(19) United States
(12) Patent Application Publication
(10) Pub. No.: US 2023/0042389 A1
(43) Pub. Date: Feb. 9, 2023

(54) INFORMATION PROCESSING DEVICE, INFORMATION PROCESSING METHOD, AND PROGRAM RECORDING MEDIUM

(71) Applicant: NEC Corporation, Minato-ku, Tokyo (JP)

(72) Inventors: Osamu SAKAGUCHI, Tokyo (JP); Tomohiro Hatae, Tokyo (JP); Yoji Aoki, Tokyo (JP)

(73) Assignee: NEC Corporation, Minato-ku, Tokyo (JP)

(21) Appl. No.: 17/788,008

(22) PCT Filed: Mar. 23, 2020
(86) PCT No.: PCT/JP2020/012717

§ 371 Date: Jun. 22, 2022

(51) Int. Cl. G06V 40/16; G06V 20/52

(52) U.S. Cl. CPC G06V 40/172; G06V 20/52

(57) ABSTRACT

An information processing device includes: an acquisition unit that acquires a first image by capturing a subject at a first distance, and extracting, from a registered biological information group that includes biological information of a plurality of registrants, a first biological information group that contains biological information of a first person detected from the first image; and a collation unit that collates biological information of a second person detected from a second image obtained by capturing the subject at a second distance, which is shorter than the distance to the subject in the first image with the biological information included in the first biological information group.

### TECHNICAL FIELD

The present invention relates to an information processing device, an information processing system, an information processing method, and a program.

### BACKGROUND ART

PTL 1 discloses an entry and exit management system provided with an authentication server that collates input biological information with biological information on a registered user to perform identity confirmation, and unlocks a gate on the basis of authentication permission from the authentication server.

### Citation List

### Patent Literature

[PTL 1] JP 6246403 B

### SUMMARY OF INVENTION

### Technical Problem

In the system exemplified in PTL 1, a face feature amount of a person captured in an authentication area is collated with face feature amounts of N (an integer of 2 or more) registrants stored in advance in a database in order. For this reason, if the number N of elements of a registrant population increases, authentication accuracy and authentication speed in face authentication may decrease.

Therefore, in view of the above-described problem, an object of the present invention is to provide an information processing device, an information processing system, an information processing method, and a program capable of improving the authentication accuracy and the authentication speed in the face authentication.

### Solution to Problem

According to one aspect of the present invention, an information processing device is provided, which includes an acquisition unit configured to extract, from a registered biological information group including biological information of a plurality of registrants, a first biological information group including biological information on a first person detected from a first image obtained by capturing an object at a first distance; and a collation unit configured to collate biological information on a second person detected from a second image obtained by capturing the object at a second distance shorter than the distance to the object in the first image with the biological information included in the first biological information group.

According to another aspect of the present invention, an information processing device is provided, which includes a storage unit configured to store a registered biological information group including biological information of a plurality of registrants; a first collation unit configured to collate biological information on a first person detected from a first image obtained by capturing an object at a first distance with biological information included in the registered biological information group; a specifying unit configured to extract a first biological information group including the biological information on the first person from the registered biological information group based on a collation result in the first collation unit; and a second collation unit configured to collate biological information on a second person detected from a second image obtained by capturing the object at a second distance shorter than the distance to the object in the first image with biological information included in the first biological information group.

According to still another aspect of the present invention, an information processing system is provided, which includes a first server configured to collate a registered biological information group including biological information of a plurality of registrants with biological information on a first person detected from a first image obtained by capturing an object at a first distance, and extract a first biological information group including the biological information on the first person from the registered biological information group; and a second server configured to collate biological information on a second person detected from a second image obtained by capturing the object at a second distance shorter than the distance to the object in the first image with biological information included in the first biological information group.

According to still another aspect of the present invention, an information processing method is provided, which includes a step of acquiring a first image obtained by capturing an object at a first distance; a step of extracting, from a registered biological information group including biological information of a plurality of registrants, a first biological information group including biological information on a first person detected from the first image; a step of acquiring a second image obtained by capturing the object at a second distance shorter than the distance to the object in the first image; and a step of collating biological information on a second person detected from the second image with the biological information included in the first biological information group.

According to still another aspect of the present invention, a program is provided, which causes a computer to execute: processing of acquiring a first image obtained by capturing an object at a first distance; processing of extracting, from a registered biological information group including biological information of a plurality of registrants, a first biological information group including biological information on a first person detected from the first image; processing of acquiring a second image obtained by capturing the object at a second distance shorter than the distance to the object in the first image; and processing of collating biological information on a second person detected from the second image with the biological information included in the first biological information group.

### Advantageous Effects of Invention

According to the present invention, an information processing device, an information processing system, an information processing method, and a program capable of improving the authentication accuracy and the authentication speed in the face authentication can be provided.

### BRIEF DESCRIPTION OF DRAWINGS

FIG. 1 is a diagram illustrating an overall configuration example of an information processing system according to a first example embodiment.

FIG. 2 is a diagram for describing a positional relationship among a plurality of authentication areas in the first example embodiment.

FIG. 3 is a block diagram illustrating a hardware configuration example of a center server and a relay server in the first example embodiment.

FIG. 4 is a functional block diagram of the information processing system according to the first example embodiment.

FIG. 5 is a diagram illustrating an example of registrant information stored in the center server according to the first example embodiment.

FIG. 6 is a diagram illustrating an example of candidate information stored in the relay server according to the first example embodiment.

FIG. 7 is a sequence diagram illustrating an example of processing of the information processing system according to the first example embodiment.

FIG. 8 is a diagram illustrating an overall configuration example of an information processing system according to a second example embodiment.

FIG. 9 is a functional block diagram of the information processing system according to the second example embodiment.

FIG. 10 is a diagram illustrating an example of member information stored in an external server according to the second example embodiment.

FIG. 11 is a sequence diagram illustrating an example of processing of the information processing system according to the second example embodiment.

FIG. 12 is a diagram illustrating an overall configuration example of an information processing system according to a third example embodiment.

FIG. 13 is a flowchart illustrating an example of processing of a relay server according to the third example embodiment.

FIG. 14 is a functional block diagram of an information processing system according to a fourth example embodiment.

FIG. 15 is a sequence diagram illustrating an example of processing of the information processing system according to the fourth example embodiment.

FIG. 16 is a diagram illustrating an overall configuration example of an information processing system according to a fifth example embodiment.

FIG. 17 is a sequence diagram illustrating an example of processing of the information processing system according to the fifth example embodiment.

FIG. 18 is a functional block diagram of an information processing device according to a sixth example embodiment.

FIG. 19 is a functional block diagram of an information processing device according to a seventh example embodiment.

FIG. 20 is a functional block diagram of an information processing device according to an eighth example embodiment.

FIG. 21 is a functional block diagram of an information processing system according to a ninth example embodiment.

FIG. 22 is a flowchart illustrating an example of processing of a relay server according to a modified example embodiment.

FIG. 23 is a diagram illustrating an example of information stored in a management server according to the modified example embodiment.

FIG. 24 is a diagram describing a positional relationship among a plurality of authentication areas according to the modified example embodiment.

### EXAMPLE EMBODIMENT

Hereinafter, example embodiments of the present invention will be described with reference to the drawings. Similar elements or corresponding elements may be designated by the same reference signs in the drawings, and description thereof may be omitted or simplified.

### First Example Embodiment

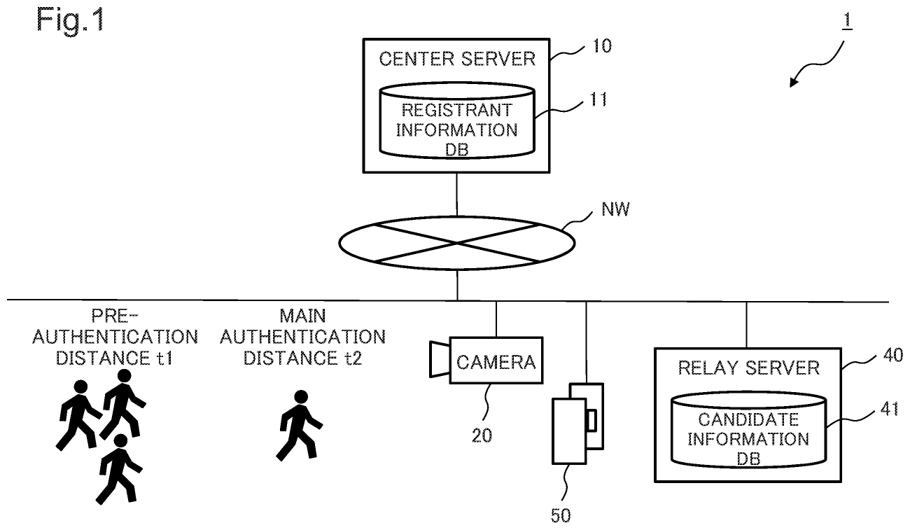

A configuration of an information processing system 1 according to the present example embodiment will be described with reference to FIGS. 1 to 6. The information processing system 1 of the present example embodiment is a computer system that manages entry and exit of a large number of people using a face authentication technique in a large-scale facility such as an event venue, a theme park, a transportation facility (a railway or an airport), or a hotel.

FIG. 1 is a diagram illustrating an overall configuration example of the information processing system 1 according to the present example embodiment. As illustrated in FIG. 1, the information processing system 1 includes a center server 10, a camera 20, a relay server 40, and a gate device 50. The devices are connected to a network NW such as a local area network (LAN) or the Internet.

The center server 10 is an information processing device (first server) that centrally manages information on a base. FIG. 1 illustrates only one base, but the number of bases is not limited thereto. Furthermore, the center server 10 includes a registrant information database 11 (hereinafter referred to as a “registrant information DB”) that stores in advance biological information on a person (hereinafter referred to as “registrant”) who desires to use the present system. The biological information is a face image, a fingerprint image, an iris image, a finger vein image, a palm print image, a palm vein image, or the like. The biological information may be one or a plurality of pieces of biological information.

Note that the phrase “biological information” in the present example embodiment means the face image and a feature amount extracted from the face image. The face image of the registrant is obtained by, for example, uploading an image file from a user when the user performs member registration online. Furthermore, the center server 10 and the relay server 40 each have a function to detect the biological information on a person from a received captured image. The feature amount (also referred to as “face feature amount”) extracted from the face image can be, for example, an amount indicating a feature of the face such as a position of a characteristic part such as a pupil, a nose, or a mouth end.

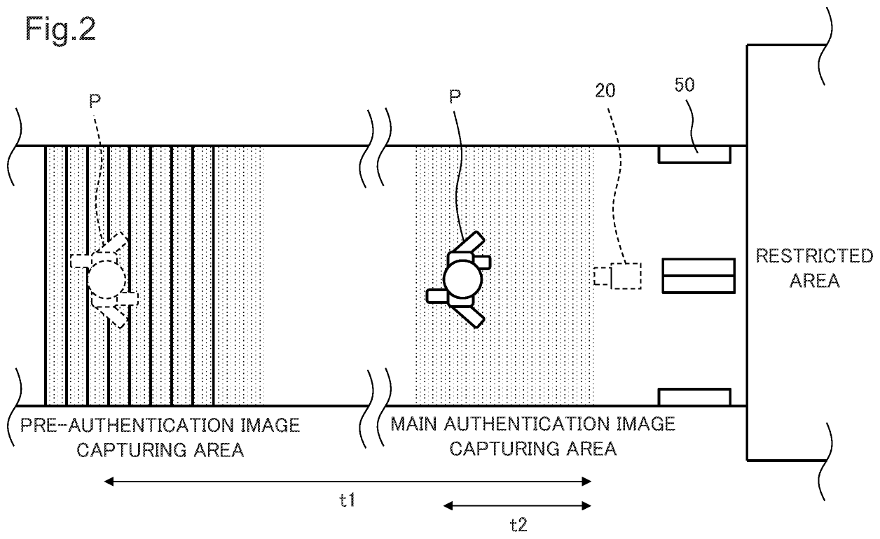

FIG. 2 is a diagram for describing a relationship between capture positions of two images captured by the camera 20 in the present example embodiment. As illustrated in FIGS. 1 and 2, a first image (pre-authentication image) is captured at a position where the camera 20 and an object are separated by a distance t1. A second image (main authentication image) is captured at a position where the camera 20 and the object are separated by a distance t2 that is shorter than the distance t1. Note that the distance tl may not be a fixed value, and for example, the distance between the camera 20 and the object at timing when a predetermined number of face images can be recognized in the image obtained from the camera may be set as t1. Therefore, an area where the first image can be obtained can be grasped as an area having a certain size as illustrated in FIG. 2 (see a pre-authentication image capturing area in FIG. 2). Similarly, the authentication distance t2 may not be a fixed value, and for example, the distance between the camera 20 and the object at timing when a face image with a certain size or certain collation accuracy can be recognized in the image obtained from the camera may be set as t2. Therefore, an area where the second image can be obtained can be grasped as an area having a certain size as illustrated in FIG. 2 (see a main authentication image capturing area in FIG. 2). In other words, the pre-authentication image capturing area (first area) is an area for performing pre-authentication, and is set at a position farther from a restricted area restricted by the gate device 50 than a position of the main authentication image capturing area (second area). In contrast, the main authentication image capturing area (second area) is an area for performing final authentication, and is set at a position close to the restricted area.

In the present example embodiment, the description will be given on the assumption that the camera 20 captures the main authentication image at the timing when approach (or entry) of the user is detected by a sensor provided in or in the vicinity of the gate device 50. With such a configuration, the main authentication image can be obtained at the position where the camera 20 and the object are separated by the distance t2. Similarly for the pre-authentication image, the pre-authentication image may be captured at the position where the camera 20 and the object are separated by the distance t1 by causing the camera 20 to capture the image by a sensor installed at a position separated from the gate device 50 by a predetermined distance.

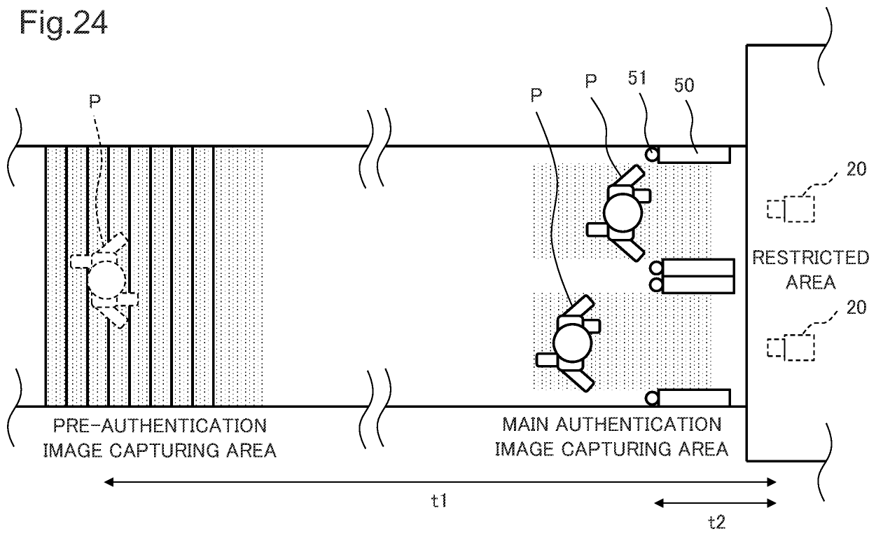

Furthermore, as illustrated in FIG. 24, a configuration in which a sensor 51 is arranged near an entrance of a lane of the gate device 50 and the camera 20 is arranged at a position where the lane can be seen can also be adopted. Then, the camera 20 captures an image of the user passing through the lane at predetermined timing after the user enters the gate device 50 on the basis of a notification from the sensor 51. In this way, a good main authentication image in a state where the user faces the camera 20 can be obtained. Note that the distances t1 and t2 between the camera 20 and the object in this case are also as illustrated in the lower part of FIG. 24. Note that the camera 20 and the sensor 51 may be provided in the gate device 50.

The camera 20 is a capture device that captures the object located at the distance t1 and the distance t2 and generates the first image (pre-authentication image) and the second image (main authentication image).

As illustrated in FIGS. 1 and 2, the camera 20 is favorably installed on an extension in a traveling direction (traffic line) of the user who is moving to the restricted area. Note that not only one camera 20 but also a plurality of cameras can be installed for each gate 50 installed at a boundary between the restricted area and a non-restricted area.

The center server 10 collates a registered biological information group including biological information of a plurality of registrants with biological information on a person (hereinafter referred to as a “first person”) detected from the first image (pre-authentication image) on the basis of a request from the relay server 40, and extracts a first biological information group including the biological information on the first person from the registered biological information group. Then, the center server 10 transmits the first biological information group narrowed down from the registered biological information group (registrant information) to the relay server 40 as candidate information.

The relay server 40 is an information processing device (second server) that performs face authentication processing for a person in each base. The relay server 40 collates biological information on a person (hereinafter referred to as a “second person”) detected from the second image (main authentication image) captured in the main authentication image capturing area with the biological information included in the first biological information group. The relay server 40 includes a candidate information database 41 (hereinafter referred to as a “candidate information DB”) that stores the candidate information (first biological information group) received from the center server 10.

The gate device 50 is a passage restriction device installed at the boundary between the restricted area and the non-restricted area. The gate device 50 is not limited to a passage restriction device such as an automatic ticket gate, and may be an automatic door-type passage restriction device. Furthermore, the gate device 50 may not have a passage restriction function, and may be, for example, a device having a function to display a result (passable or impassable) of person authentication by the relay server 40.

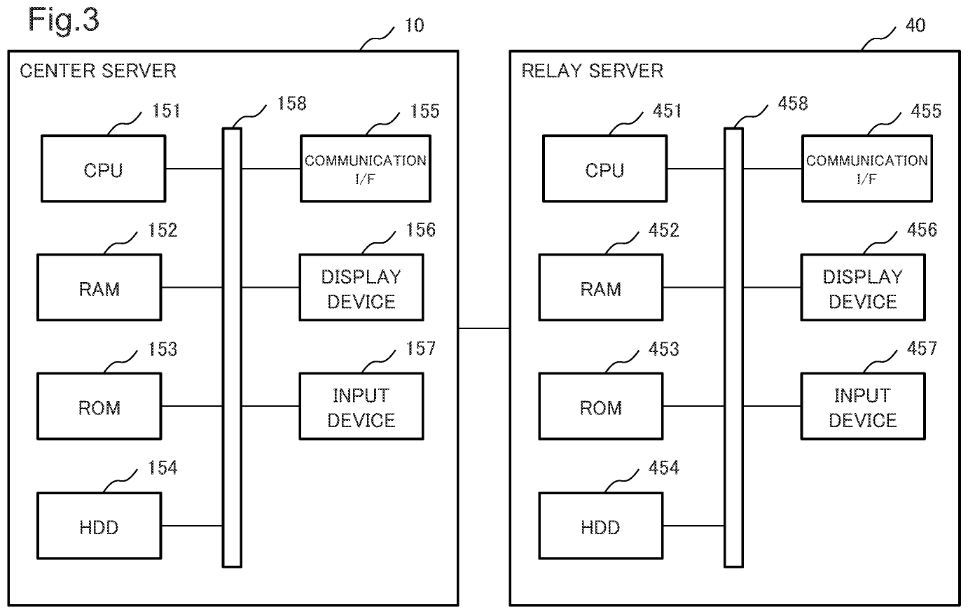

FIG. 3 is a block diagram illustrating a hardware configuration example of the center server 10 and the relay server 40. The center server 10 includes a central processing unit (CPU) 151, a random access memory (RAM) 152, a read only memory (ROM) 153, and a hard disk drive (HDD) 154 as a computer that performs calculation, control, and storage. Furthermore, the information processing system 1 includes a communication interface (I/F) 155, a display device 156, and an input device 157. The CPU 151, the RAM 152, the ROM 153, the HDD 154, the communication I/F 155, the display device 156, and the input device 157 are connected to one another via a bus 158. Note that the display device 156 and the input device 157 may be connected to the bus 158 via a drive device (not illustrated) for driving these devices.

Note that, in FIG. 3, the units constituting the center server 10 are illustrated as an integrated device, but some of these functions may be provided by an external device. For example, the display device 156 and the input device 157 may be external devices different from a part constituting functions of the computer including the CPU 151 and the like.

The CPU 151 is a processor that performs a predetermined operation according to a program stored in the ROM 153, the HDD 154, or the like and has a function to control each unit of the center server 10. The RAM 152 includes a volatile storage medium and provides a temporary memory area necessary for the operation of the CPU 151. The ROM 153 includes a non-volatile storage medium, and stores necessary information such as a program used for the operation of the center server 10. The HDD 154 is a storage device including a non-volatile storage medium, and which stores data necessary for processing, an operation program of the center server 10, and the like.

The communication I/F 155 is a communication interface based on standards such as Ethernet (registered trademark), Wi-Fi (registered trademark), 4G, or 5G, and is a module for communicating with other devices. The display device 156 is a liquid crystal display, an organic light-emitting diode (OLED) display, or the like, and is used for displaying an image, a character, an interface, or the like. The input device 157 is a keyboard, a pointing device, or the like, and is used by the user to operate the information processing system 1. Examples of the pointing device include a mouse, a track ball, a touch panel, and a pen tablet. The display device 156 and the input device 157 may be integrally formed as a touch panel.

Note that functions of a CPU 451, a RAM 452, a ROM 453, an HDD 454, a communication I/F 455, a display device 456, an input device 457, and a bus 458 included in the relay server 40 are similar to those of the CPU 151, the RAM 152, the ROM 153, the HDD 154, the communication I/F 155, the display device 156, the input device 157, and the bus 158 of the center server 10, and thus description thereof is omitted.

Furthermore, the hardware configuration illustrated in FIG. 3 is an example, and devices other than these devices may be added, or some devices may not be provided. In addition, some devices may be replaced with other devices having a similar function. Furthermore, some functions of the present example embodiment may be provided by another device via a network, or the functions of the present example embodiment may be implemented by being distributed to a plurality of devices. For example, the HDD 154 may be replaced with a solid state drive (SSD) using a semiconductor memory, or may be replaced with a cloud storage.

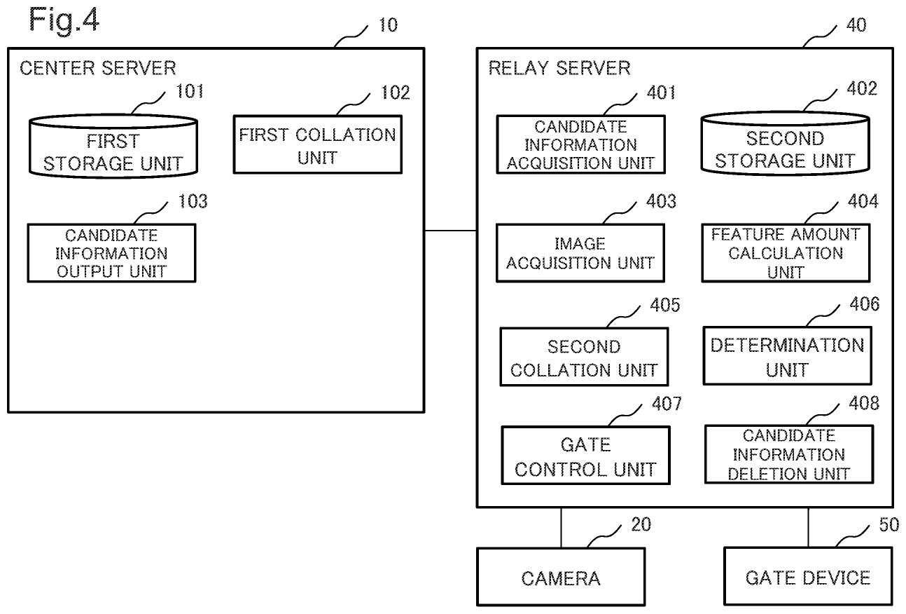

FIG. 4 is a functional block diagram of the information processing system 1 according to the present example embodiment. The center server 10 includes a first storage unit 101, a first collation unit 102, and a candidate information output unit 103. Furthermore, the relay server 40 includes a candidate information acquisition unit 401, a second storage unit 402, an image acquisition unit 403, a feature amount calculation unit 404, a second collation unit 405, a determination unit 406, a gate control unit 407, and a candidate information deletion unit 408.

The CPU 151 of the center server 10 loads a program stored in the ROM 153, the HDD 154, or the like into the RAM 152 and executes the program. As a result, the CPU 151 of the center server 10 implements the functions of the first collation unit 102 and the candidate information output unit 103. Moreover, the CPU 151 of the center server 10 implements the function of the first storage unit 101 by controlling the HDD 154. In the present example embodiment, the registrant information database 11 corresponds to the first storage unit 101.

Similarly, the CPU 451 of the relay server 40 loads a program stored in the ROM 453, the HDD 454, or the like into the RAM 452 and executes the program. As a result, the CPU 451 of the relay server 40 implements the functions of the candidate information acquisition unit 401, the image acquisition unit 403, the feature amount calculation unit 404, the second collation unit 405, the determination unit 406, the gate control unit 407, and the candidate information deletion unit 408. Processing performed in each unit will be described below. Moreover, the CPU 451 of the relay server 40 implements the function of the second storage unit 402 by controlling the HDD 454. In the present example embodiment, the candidate information database 41 corresponds to the second storage unit 402.

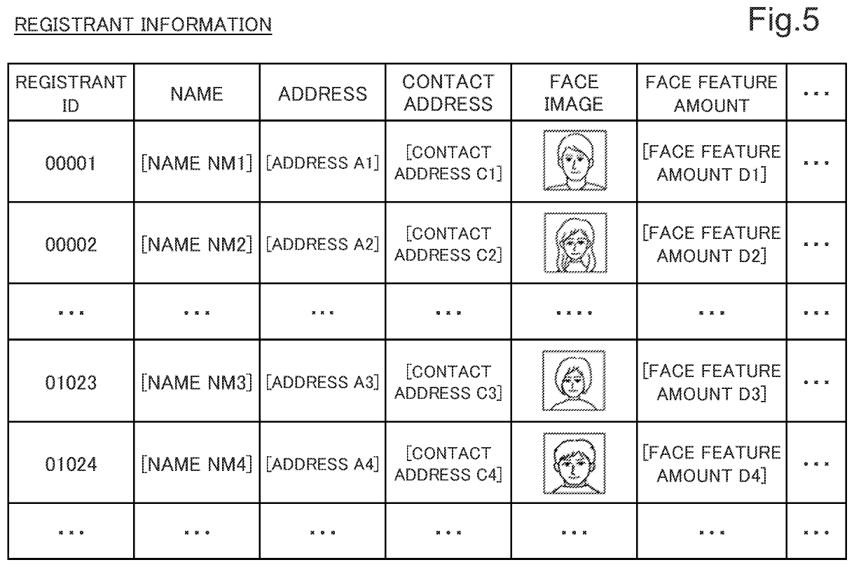

FIG. 5 is a diagram illustrating an example of the registrant information stored in the center server 10 (registrant information DB 11) according to the present example embodiment. Here, data items of the registrant information include a registrant ID, a name, an address, a contact address, a face image, and a face feature amount. For example, in the registrant information on the registrant ID “00001”, the name of the person is “[name NM1]”, the address is “[address A1]”, and the contact address is “[contact address C1]”. Then, the face feature amount (biological information) calculated from the face image of the person with the registrant ID “00001” is “[face feature amount D1]”.

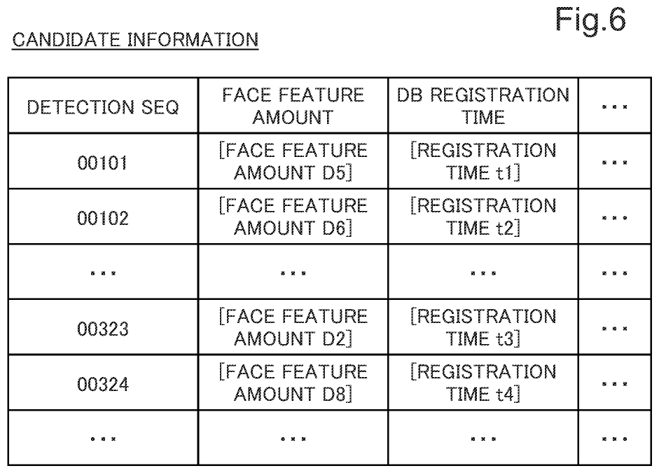

FIG. 6 is a diagram illustrating an example of the candidate information stored in the relay server 40 (candidate information DB 41) according to the present example embodiment. Here, data items of the candidate information include detection SEQ, a face feature amount, and DB registration time. The detection SEQ indicates a detection order in the pre-authentication area. The DB registration date and time indicates date and time when the candidate information received from the center server 10 is registered in the candidate information database 41. For example, the candidate information on the detection SEQ “00101” indicates that the face feature amount is “[face feature amount D5]” and information is registered in the candidate information DB 41 when the DB registration time is “[registration time t1]”.

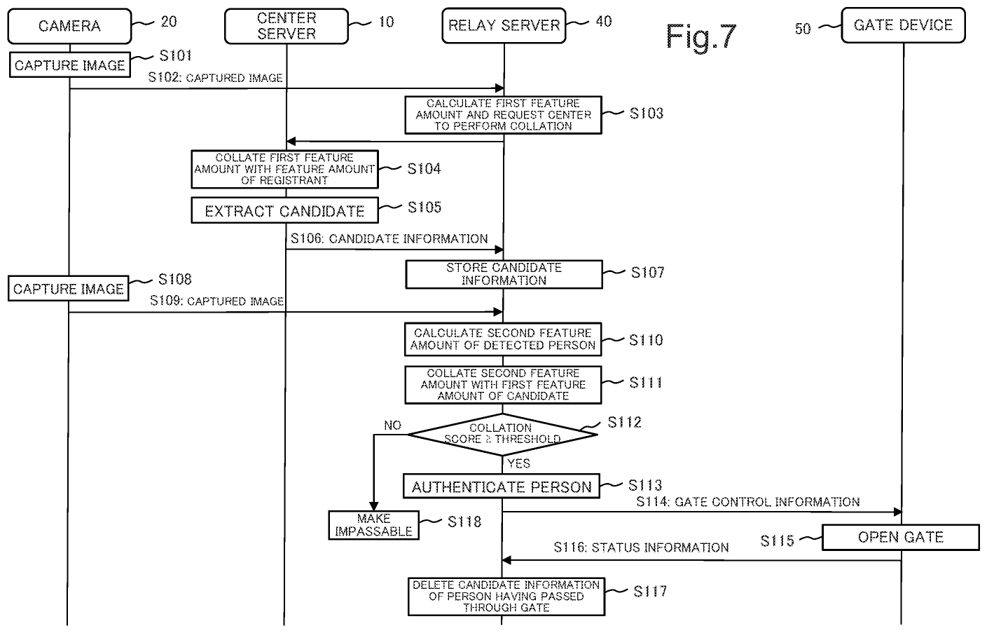

Next, functions and effects of the information processing system 1 according to the present example embodiment will be described with reference to FIG. 7. FIG. 7 is a sequence diagram illustrating an example of processing of the information processing system 1.

First, the image acquisition unit 403 of the relay server 40 causes the camera 20 to capture the object located in the pre-authentication capturing area (step S101) and acquires the captured image (first image; pre-authentication image) (step S102). Next, the feature amount calculation unit 404 of the relay server 40 calculates first feature amounts of at least one or more detected persons (first persons) included in the received captured image, and requests the center server 10 to perform collation (step S103).

Next, the first collation unit 102 of the center server 10 collates the first feature amount of the detected person received from the relay server 40 with the feature amount of the registrant stored in the registrant information DB 11 (step S104). Next, the first collation unit 102 extracts the registrant having a score of collation of the first feature amount of the detected person with the feature amount of the registrant, the score of collation being equal to or larger than a predetermined threshold (determination reference value), as a candidate (step S105). Note that the number of candidates extracted by the center server 10 is not limited to one. In a case where there is a plurality of persons having the collation score that is equal to or larger than the predetermined threshold (determination reference value), the plurality of persons may be extracted.

Next, the candidate information output unit 103 of the center server 10 transmits the candidate information on the person extracted from the registrants by the collation processing to the relay server 40 (step S106). Next, the candidate information acquisition unit 401 of the relay server 40 stores the candidate information received from the center server 10 in the candidate information database 41 that is the second storage unit 402 (step S107).

The image acquisition unit 403 of the relay server 40 causes the camera 20 to capture an image of the object located in the main authentication capturing area (step S108) and acquires the captured image (second image; main authentication image) (step S109). Next, the feature amount calculation unit 404 of the relay server 40 calculates a second feature amount of the detected person (second person) included in the received captured image (second image) (step S110). Then, the second collation unit 405 of the relay server 40 collates the second feature amount with the first feature amount of the candidate (step S111).

Next, the determination unit 406 of the relay server 40 determines whether the score of collation of the second feature amount of the detected person with the first feature amount of the candidate is equal to or larger than the predetermined threshold (determination reference value) (step S112). Here, in a case of determining that the collation score of the feature amount is equal to or larger than the threshold (step S112: YES), the determination unit 406 of the relay server 40 specifies the candidate having the highest collation score of the feature amount from among the corresponding candidates and authenticates the detected person (step S113). That is, the two feature amounts are considered to be matched. Next, the gate control unit 407 of the relay server 40 transmits gate control information to the gate device 50 (step S114).

When opening a gate on the basis of the gate control information received from the relay server 40 (step S115), the gate device 50 transmits status information indicating completion of the gate opening to the relay server 40 (step S116).

When determining that the collation score of the feature amount is less than the threshold (step S112: NO), the determination unit 406 of the relay server 40 determines that the detected person (second person) is impassable (step S118) and terminates the processing. In this case, the closed state is maintained in the gate device 50.

In step S117, the candidate information deletion unit 408 of the relay server 40 deletes the candidate information on the person who has passed through the gate from the candidate information database 41, and terminates the processing. Note that, in the above-described processing, the description has been given on the assumption that an initial state of the gate device 50 is the closed state, but the initial state may be an open state. In this case, when it is determined that the collation score is less than the threshold, the gate device 50 may be controlled from the open state to the closed state. Furthermore, in the case where the collation score is less than the threshold value, an alert may be output from the gate device 50 or the like by voice, light, text, or the like, for example, instead of controlling the opening/closing operation of the gate device 50.

The information processing system 1 in the present example embodiment adopts the first person detected from the captured image (first image) captured in the pre-authentication capturing area as the candidate for the collation processing with the person detected from the captured image (second image) in the main authentication capturing area in the case where the first person is registered as a registrant. More specifically, the information processing system 1 specifies the first person from among a plurality of registrants, and transmits the candidate information thereof to the relay server 40. Then, the final authentication is performed by comparing the feature amounts between the candidate narrowed down in the pre-authentication capturing area and the person detected from the captured image in the main authentication capturing area. That is, since the information processing system has a configuration in which the final authentication is performed after the number of persons belonging to a population N of one-to-N authentication is significantly reduced, the authentication accuracy and the authentication speed in the final authentication can be significantly improved.

Furthermore, as illustrated in step S117 of FIG. 7, the information processing system 1 according to the present example embodiment is configured to quickly delete the information on the candidate for which the main authentication has been completed after passing through the gate. Therefore, it is possible to prevent unnecessary candidate information from being accumulated in the candidate information database 41 of the relay server 40. As a result, a decrease in the authentication accuracy and the authentication speed in the one-to-N face authentication can be prevented.

### Second Example Embodiment

Hereinafter, an information processing system 2 according to a second example embodiment will be described. Note that the same reference signs as those assigned in the drawings of the first example embodiment represent the same objects. Therefore, description of portions common to the first example embodiment will be omitted, and different portions will be described in detail.

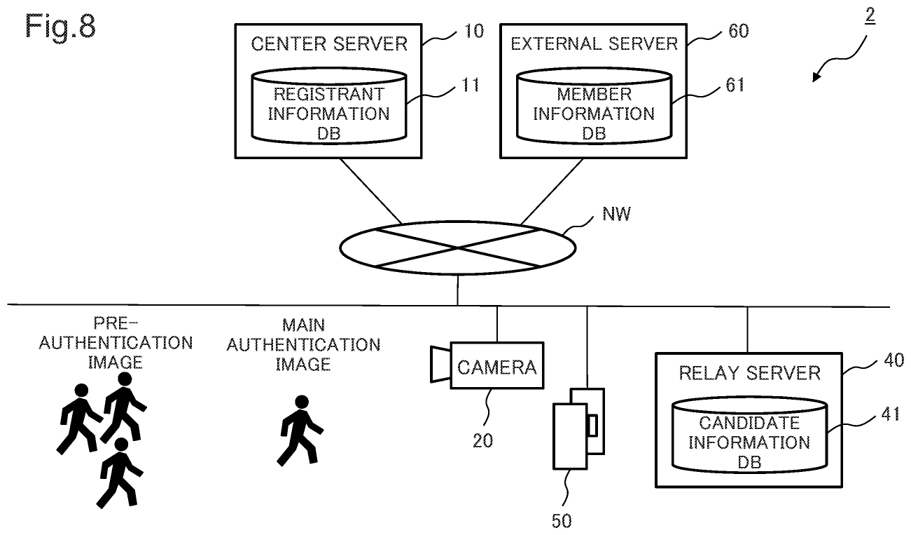

FIG. 8 is a diagram illustrating an overall configuration example of the information processing system 2 according to the present example embodiment. As illustrated in FIG. 8, a relay server 40 is connected to an external server 60 via a network NW. The external server 60 is, for example, a server used for providing a service by a company different from a company that manages a center server 10, and includes a member information database (member information DB) 61.

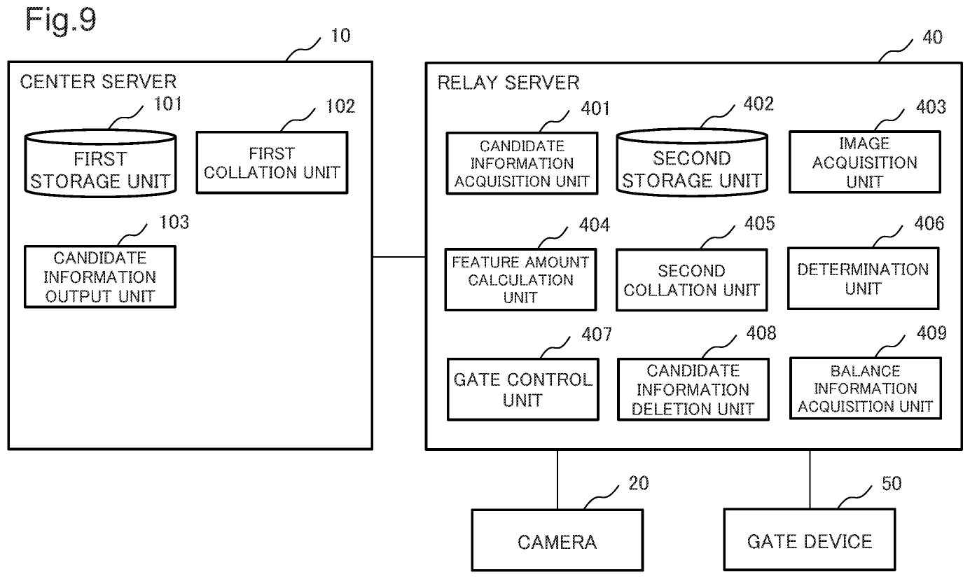

FIG. 9 is a functional block diagram of the information processing system 2 according to the present example embodiment. As illustrated in FIG. 9, the relay server 40 of the present example embodiment is different from that of the first example embodiment in further including a balance information acquisition unit 409 that acquires balance information on electronic money of a member from the external server 60.

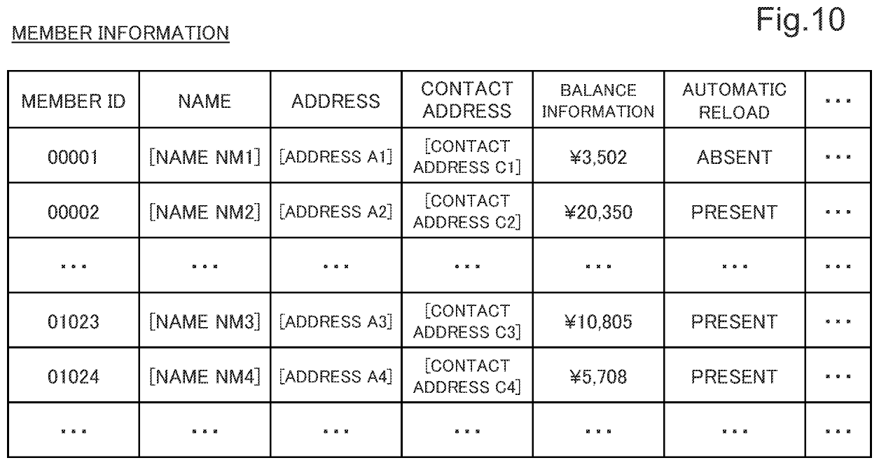

FIG. 10 is a diagram illustrating an example of the member information stored in the external server 60 according to the present example embodiment. Here, examples of data items of the member information include a member ID, a name, an address, a contact address, balance information, and automatic reload. The member ID is an ID unique to each member. The balance information indicates the balance of electronic money that can be used by the member for various services. The automatic reload indicates presence or absence of setting of a service for automatically adding a set amount in a case where the balance falls below a certain amount. In the present example embodiment, the member ID is an ID corresponding to the registrant ID illustrated in FIG. 5, but may be another ID associated with the registrant ID.

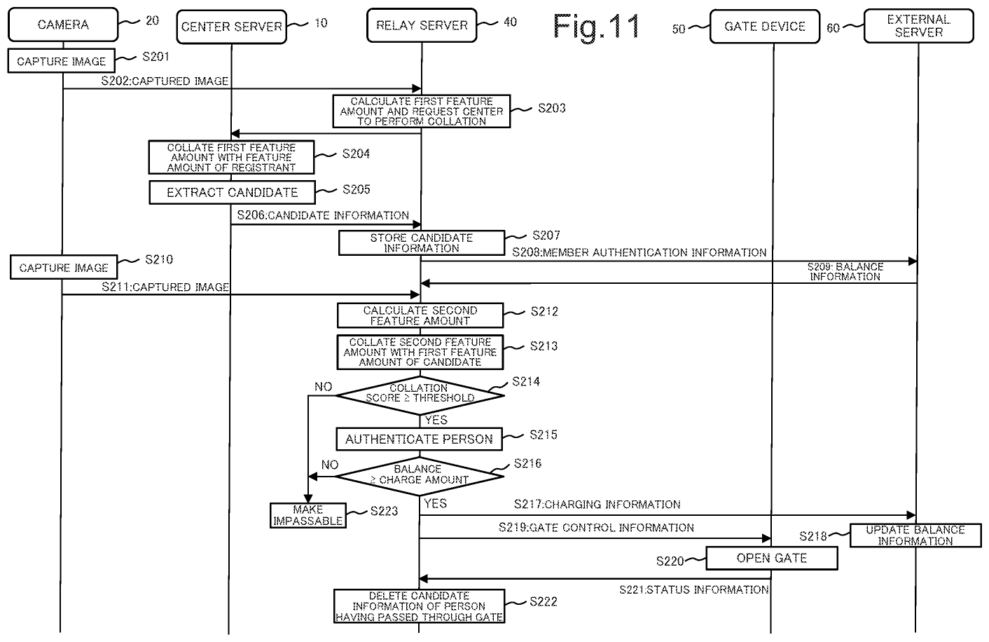

Next, functions and effects of the information processing system 2 according to the present example embodiment will be described with reference to FIG. 11. FIG. 11 is a sequence diagram illustrating an example of processing of the information processing system 2.

First, an image acquisition unit 403 of the relay server 40 causes a camera 20 to capture an object located in a pre-authentication capturing area (step S201) and acquires a captured image (first image; pre-authentication image) (step S202). Next, a feature amount calculation unit 404 of the relay server 40 calculates first feature amounts of at least one or more detected persons (first persons) included in the received captured image, and requests the center server 10 to perform collation (step S203).

Next, a first collation unit 102 of the center server 10 collates the first feature amount of the detected person with a feature amount of a registrant stored in a registrant information DB 11 (step S204). Next, the first collation unit 102 extracts the registrant having a score of collation of the first feature amount of the detected person with the feature amount of the registrant, the score of collation being equal to or larger than a predetermined threshold (determination reference value), as a candidate (step S205). Note that the number of candidates extracted by the center server 10 is not limited to one. In a case where there is a plurality of persons having the collation score that is equal to or larger than the predetermined threshold (determination reference value), the plurality of persons may be extracted.

Next, a candidate information output unit 103 of the center server 10 transmits candidate information on the person extracted from the registrants by the collation processing to the relay server 40 (step S206). Next, a candidate information acquisition unit 401 of the relay server 40 stores the candidate information received from the center server 10 in a candidate information database 41 that is a second storage unit 402 (step S207).

Next, the balance information acquisition unit 409 of the relay server 40 transmits member authentication information on the extracted person to the external server 60 (step S208). The member authentication information can be acquired from the center server 10 together with, for example, the candidate information. The external server 60 acquires the balance information on the electronic money of the corresponding person from the member information database 61 on the basis of the member authentication information received from the relay server 40, and returns the information to the relay server 40 (step S209).

The image acquisition unit 403 of the relay server 40 causes the camera 20 to capture an image of the object located in a main authentication capturing area (step S210) and acquires the captured image (second image; main authentication image) (step S211). Next, the feature amount calculation unit 404 of the relay server 40 calculates a second feature amount of the detected person (second person) included in the received captured image (second image) (step S212). Then, a second collation unit 405 of the relay server 40 collates the second feature amount with the first feature amount of the candidate (step S213).

Next, a determination unit 406 of the relay server 40 determines whether the score of collation of the second feature amount of the detected person with the first feature amount of the candidate is equal to or larger than the predetermined threshold (determination reference value) (step S214). Here, in a case of determining that the collation score of the feature amount is equal to or larger than the threshold (step S214: YES), the determination unit 406 of the relay server 40 specifies the candidate having the highest collation score of the feature amount from among the corresponding candidates and authenticates the detected person (step S215). Thereafter, the processing proceeds to step S216.

On the other hand, in a case of determining that the collation score of the feature amount is less than the threshold (step S214: NO), the determination unit 406 of the relay server 40 determines that the second person is impassable (step S223) and terminates the processing.

In step S216, the determination unit 406 of the relay server 40 refers to the balance information on the first person and determines whether the balance is equal to or larger than a charge amount. Here, in a case where the determination unit 406 of the relay server 40 determines that the balance is equal to or larger than the charge amount (step S216: YES), the relay server 40 transmits charging information to the external server 60 (step S217). Upon receiving the charging information, the external server 60 updates the balance information included in the member information in the member information database 61 (step S218).

Furthermore, a gate control unit 407 of the relay server 40 transmits gate control information to a gate device 50 (step S219) in parallel with the processing of step S217.

When opening a gate on the basis of the gate control information received from the relay server 40 (step S220), the gate device 50 transmits status information indicating completion of the gate opening to the relay server 40 (step S221).

In a case of determining that the electronic money balance is less than the charge amount (step S216: NO), the determination unit 406 of the relay server 40 determines that the second person is impassable (step S223) and terminates the processing. In this case, the closed state is maintained in the gate device 50.

In step S222, a candidate information deletion unit 408 of the relay server 40 deletes the candidate information on the person who has passed through the gate from the candidate information DB 41, and terminates the processing. In the sequence diagram of FIG. 11, after the determination processing for the collation score of the first feature amount and the second feature amount (step S214), the comparison processing for the balance and the charge amount has been performed (step S216), but the processing order is not limited thereto. For example, the comparison processing between the balance of the registrant (candidate) and the charge amount (step S216) may be performed immediately after the relay server 40 receives the balance information from the external server 60. When the corresponding candidate information is deleted from the relay server 40, the relay server 40 determines that there is no candidate information with the collation score that is equal to or larger than the threshold in the subsequent determination processing (corresponding to step S214). Therefore, similarly to FIG. 11, the relay server 40 can make the registrant with an insufficient balance impassable.

As described above, the information processing system 2 according to the present example embodiment is configured to determine whether a person is passable to a restricted area in consideration of not only a collation result of a face feature amount but also the balance information of the candidate acquired from the external server 60 as a cooperation partner, and thus can determine the person who can use a service. Furthermore, since the relay server 40 has the balance information of the candidate before an image is captured by the camera 20 installed in the vicinity of the gate device 50, the relay server 40 can immediately open the gate in the case of determining that the score of collation of the second feature amount with the first feature amount of the captured images captured by the camera 20 is equal to or larger than the threshold.

Note that, in the above description, it has been described that the relay server 40 inquires of the external server 60 about the balance information of the member, but the center server 10 that has specified the candidate may perform the processing. In this case, in step S206, the center server 10 sends the balance information inquired of the external server 60 to the relay server 40 in addition to the candidate information. Therefore, steps S207 and S208 can be omitted.

### Third Example Embodiment

Hereinafter, an information processing system 3 according to a third example embodiment will be described. Note that the same reference signs as those assigned in the drawings of the first example embodiment represent the same objects. Therefore, description of portions common to the first example embodiment will be omitted, and different portions will be described in detail.

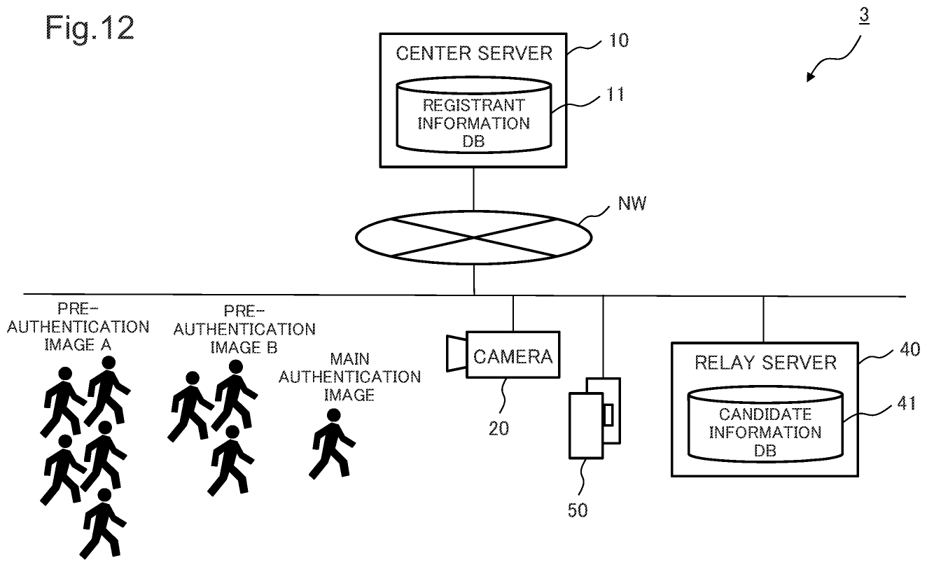

FIG. 12 is a diagram illustrating an overall configuration example of the information processing system 3. As illustrated in FIG. 12, the present example embodiment is different from the first example embodiment in that a pre-authentication capturing area is divided into two parts and a camera 20 captures pre-authentication images A and B, and that a center server 10 collates feature amounts obtained from the pre-authentication images A and B and can transmit candidate information each time of the collation. Note that three or more pre-authentication capturing areas may be set.

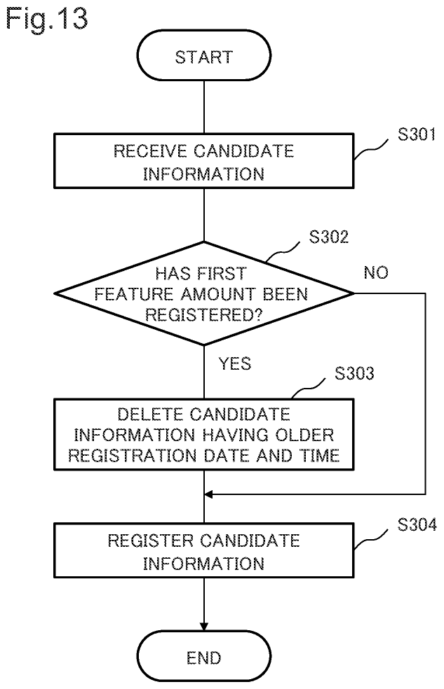

Next, functions and effects of the information processing system 3 according to the present example embodiment will be described with reference to FIG. 13. FIG. 13 is a flowchart illustrating an example of processing of a relay server 40.

First, when receiving the candidate information from the center server 10 (step S301), a candidate information acquisition unit 401 of the relay server 40 refers to a candidate information DB 41 (second storage unit 402) and determines whether a first feature amount included in the candidate information is a registered feature amount (step S302). For example, in a case of receiving the candidate information obtained from the image for pre-authentication B, the relay server 40 determines presence or absence of overlapping registration with the first feature amount included in the candidate information obtained from the pre-authentication image A received before the reception of the candidate information.

Here, in a case where the candidate information acquisition unit 401 of the relay server 40 determines that the first feature amount is a registered feature amount (step S302: YES), a candidate information deletion unit 408 of the relay server 40 deletes the registered candidate information having old registration date and time (step S303). Thereafter, the processing proceeds to step S304. On the other hand, in a case where the candidate information acquisition unit 401 of the relay server 40 determines that the first feature amount is an unregistered feature amount (step S302: NO), the processing proceeds to step S304.

In step S304, the candidate information acquisition unit 401 registers the candidate information received in step S301 in the candidate information database 41, and terminates the processing. Note that, in the above-described determination processing in step S302, the overlapping has been determined according to whether the feature amount has been registered, but the determination method is not limited thereto. For example, in a case where a registrant ID is stored in the candidate information DB 41 in association with the feature amount, the overlapping candidate information may be detected and deleted on the basis of the registrant ID.

In the information processing system 3 according to the present example embodiment, persons are detected from the plurality of pre-authentication images A and B having different distances from the camera 20 to the object, and are transmitted as candidate information from the center server 10 to the relay server 40. In this case, the candidate information may be transmitted a plurality of times for the same person. However, as described in step S303, since the candidate information DB 41 is controlled such that candidates having the same feature amount are not present, unnecessary candidate information can be prevented from being accumulated. As a result, a decrease in authentication accuracy and authentication speed in one-to-N face authentication can be prevented.

### Fourth Example Embodiment

Hereinafter, an information processing system 5 according to a fourth example embodiment will be described. Note that the same reference signs as those assigned in the drawings of the first example embodiment represent the same objects. Therefore, description of portions common to the first example embodiment will be omitted, and different portions will be described in detail.

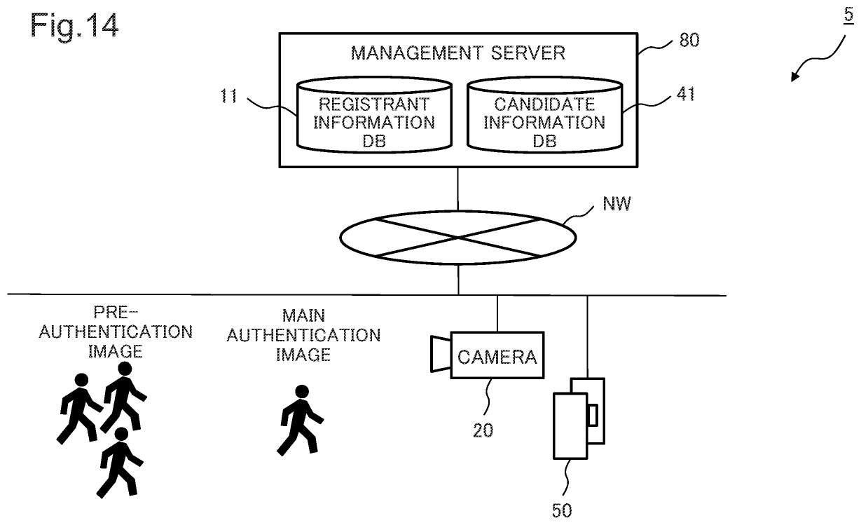

FIG. 14 is a diagram illustrating an overall configuration example of the information processing system 5 according to the present example embodiment. As illustrated in FIG. 14, the information processing system 5 is different from that of the first example embodiment in including a management server 80 in which a center server 10 and a relay server 40 are integrated instead of the center server 10 and the relay server 40.

The management server 80 has functions similar to the center server 10 and the relay server 40 illustrated in FIG. 4. Specifically, the management server 80 includes both a registrant information database 11 (first storage unit 101) and a candidate information database 41 (second storage unit 402). Note that, along with the integration, a function to transmit and receive information between servers becomes unnecessary.

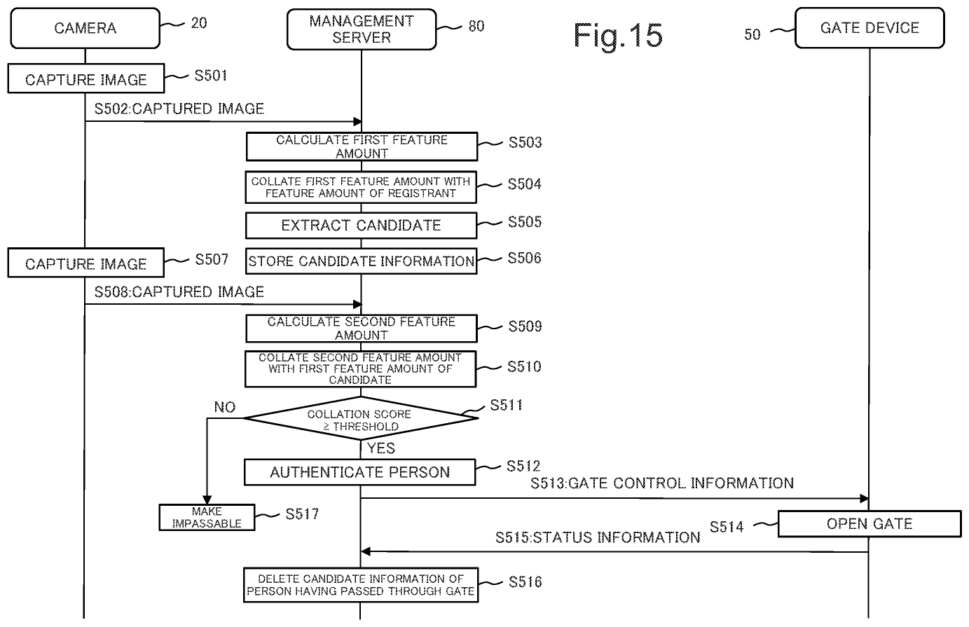

Next, functions and effects of the information processing system 5 according to the present example embodiment will be described with reference to FIG. 15. FIG. 15 is a sequence diagram illustrating an example of processing of the information processing system 5 according to the present example embodiment.

First, the management server 80 causes a camera 20 to capture an object located in a pre-authentication capturing area (step S501) and acquires a captured image of the object (first image; pre-authentication image) (step S502). Next, the management server 80 calculates a first feature amount of a detected person (first person) included in the captured image (first image) received from the camera 20 (step S503).

Next, the management server 80 collates the first feature amount of the detected person with a feature amount of a registrant stored in the registrant information DB 11 (step S504). Next, the management server 80 extracts the registrant having a score of collation of the first feature amount of the detected person with the feature amount of the registrant, the score of collation being equal to or larger than a predetermined threshold (determination reference value), as a candidate (step S505). Note that the number of candidates extracted by the center server 10 is not limited to one. In a case where there is a plurality of persons having the collation score that is equal to or larger than the predetermined threshold (determination reference value), the plurality of persons may be extracted.

Next, the management server 80 stores candidate information on the person specified from the registrants by the collation processing in the candidate information DB 41 (step S506).

Similarly, the camera 20 captures the object located in a main authentication capturing area (step S507) and transmits a captured image of the object (second image; main authentication image) to the management server 80 (step S508). Next, the management server 80 calculates a second feature amount of a detected person (second person) included in the captured image (second image) received from the camera 20 (step S509). Then, the management server 80 collates the second feature amount with the first feature amount of the candidate (step S510).

Next, the management server 80 determines whether the score of collation of the second feature amount of the detected person with the first feature amount of the candidate is equal to or larger than the predetermined threshold (determination reference value) (step S511). Here, in a case of determining that the collation score of the feature amount is equal to or larger than the threshold (step S511: YES), the management server 80 specifies the candidate having the highest collation score from among corresponding registrants and authenticates the detected person (step S512). Thereafter, the management server 80 transmits gate control information to a gate device 50 (step S513).

When opening a gate on the basis of the gate control information received from the management server 80 (step S514), the gate device 50 transmits status information indicating completion of the gate opening to the management server 80 (step S515). Thereafter, the processing proceeds to step S516.

On the other hand, in a case of determining that the collation score is less than the predetermined threshold in step S511 (step S511; NO), the management server 80 determines that the second person is impassable (step S517) and terminates the processing.

In step S516, the management server 80 deletes the candidate information on the person who has passed through the gate from the candidate information database 41, and terminates the processing.

Since the information processing system 5 according to the present example embodiment has a configuration in which the management server 80 has functions of a plurality of servers unlike the above-described first example embodiment, there is an advantage that data transmission and reception between servers is not required in addition to the effects of the above-described first example embodiment.

### Fifth Example Embodiment

Hereinafter, an information processing system 6 according to a fifth example embodiment will be described. Note that the same reference numerals as those assigned in the drawings of the second example embodiment represent the same objects. Therefore, description of portions common to the second example embodiment will be omitted, and different portions will be described in detail.

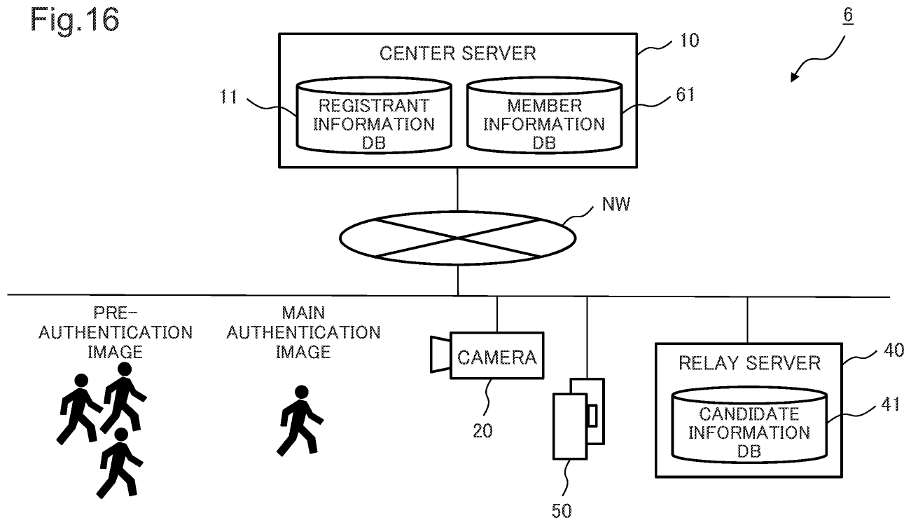

FIG. 16 is a diagram illustrating an overall configuration example of the information processing system 6 according to the present example embodiment. As illustrated in FIG. 16, a center server 10 is different from that of the second example embodiment in including a member information DB 61 in addition to a registrant information DB 11. That is, the center server 10 of the present example embodiment further includes the function of the external server 60 of the second example embodiment. Note that, in the present example embodiment, the member information DB 61 does not need to have all the data items illustrated in FIG. 10, and data items (name, address, and the like) overlapping with the registrant information DB 11 may be omitted. In addition, the registrant information DB 11 and the member information DB 61 may be integrated into one database.

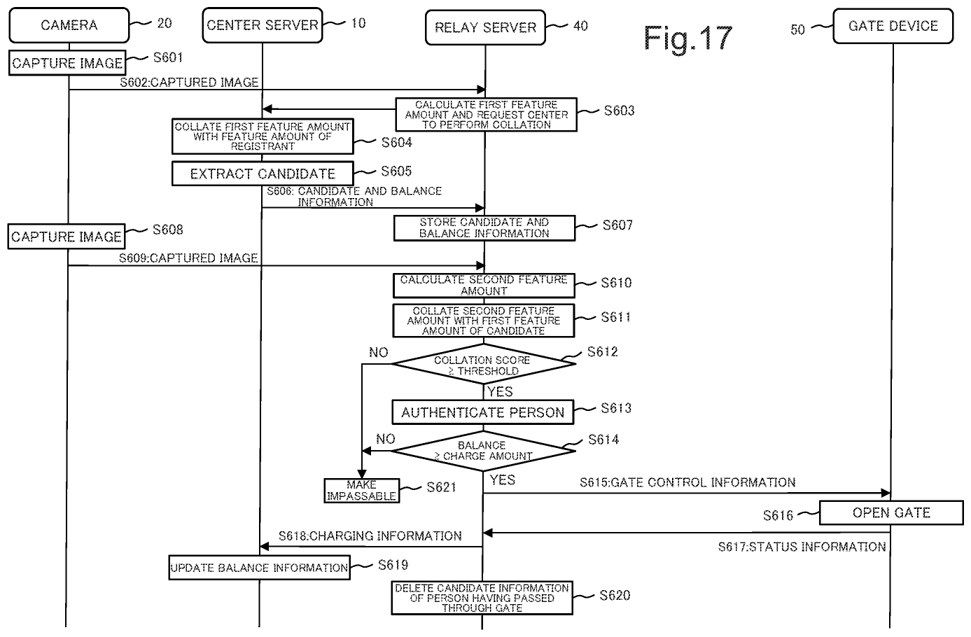

Next, functions and effects of the information processing system 6 according to the present example embodiment will be described with reference to FIG. 17. FIG. 17 is a sequence diagram illustrating an example of processing of the information processing system 6.

First, an image acquisition unit 403 of a relay server 40 causes a camera 20 to capture an object located in a pre-authentication capturing area (step S601) and acquires a captured image (first image; pre-authentication image) (step S602). Next, a feature amount calculation unit 404 of the relay server 40 calculates a first feature amount of a detected person (first person) included in the received captured image (first image), and requests the center server 10 to perform collation (step S603).

Next, a first collation unit 102 of the center server 10 collates the first feature amount of the detected person with a feature amount of a registrant stored in the registrant information DB 11 (step S604). The first collation unit 102 extracts the registrant having a score of collation of the first feature amount of the detected person with feature amount of the registrant, the score of collation being equal to or larger than a predetermined threshold (determination reference value), as a candidate (step S605). Note that the number of candidates extracted by the center server 10 is not limited to one. In a case where there is a plurality of persons having the collation score that is equal to or larger than the predetermined threshold (determination reference value), the plurality of persons may be extracted.

Next, a candidate information output unit 103 of the center server 10 transmits the feature amount (candidate information) of the candidate extracted from the registrants by the collation processing and balance information on electronic money of the candidate to the relay server 40 (step S606). The balance information on electronic money of the candidate can be acquired from member information in which the registrant ID of the candidate matches the member ID by searching the member information DB 61 using a registrant ID as a search key. Next, a candidate information acquisition unit 401 of the relay server 40 stores the candidate information and the balance information received from the center server 10 in a candidate information DB 41 that is a second storage unit 402 (step S607).

Similarly, the image acquisition unit 403 of the relay server 40 causes the camera 20 to capture an image of the object located in a main authentication capturing area (step S608) and acquires the captured image (second image; main authentication image) (step S609). Next, the feature amount calculation unit 404 of the relay server 40 calculates a second feature amount of the detected person (second person) included in the received captured image (second image) (step S610). Then, a second collation unit 405 of the relay server 40 collates the second feature amount with the first feature amount of the candidate (step S611).

Next, a determination unit 406 of the relay server 40 determines whether the score of collation of the second feature amount of the detected person with the first feature amount of the candidate is equal to or larger than the predetermined threshold (determination reference value) (step S612). Here, in a case of determining that the collation score of the feature amount is equal to or larger than the threshold (step S612: YES), the determination unit 406 of the relay server 40 specifies the candidate having the highest collation score of the feature amount from among the corresponding candidates and authenticates the detected person (step S613). Thereafter, the processing proceeds to step S614.

In a case where the determination unit 406 of the relay server 40 determines that the collation score of the feature amount is less than the threshold (step S612: NO), the determination unit 406 of the relay server 40 determines that the second person is impassable (step S621) and terminates the processing.

In step S614, the determination unit 406 of the relay server 40 refers to the balance information on the electronic money of the first person stored in the candidate information database 41, and determines whether the balance is equal to or larger than the charge amount. Here, in a case where the determination unit 406 of the relay server 40 determines that the balance is equal to or larger than the charge amount (step S614: YES), a gate control unit 407 of the relay server 40 transmits gate control information to a gate device 50 (step S615).

When opening a gate on the basis of the gate control information received from the relay server 40 (step S616), the gate device 50 transmits status information indicating completion of the gate opening to the relay server 40 (step S617).

Furthermore, the relay server 40 transmits charging information to the center server 10 (step S618) in parallel with steps S615 to S617. Upon receiving the charging information, the center server 10 updates the balance information included in the member information in the member information DB 61 (step S619).

In a case of determining that the balance is less than the charge amount (step S614: NO), the determination unit 406 of the relay server 40 determines that the second person is impassable (step S621) and terminates the processing. In this case, a closed state (initial state) is maintained in the gate device 50.

In step S620, a candidate information deletion unit 408 of the relay server 40 deletes the candidate information on the person who has passed through the gate from the candidate information DB 41, and terminates the processing. In the sequence diagram of FIG. 17, after the determination processing for the score of collation of the first feature amount with the second feature amount (step S612), the comparison processing for the balance and the charge amount has been performed (step S614), but the processing order is not limited thereto. For example, the comparison processing for the balance of the registrant (candidate) and the charge amount (step S614) may be performed immediately after the relay server 40 stores the balance information received from the center server 10 in the candidate information database 41. When the corresponding candidate information is deleted from the relay server 40, the relay server 40 determines that there is no candidate information with the collation score that is equal to or larger than the threshold in the subsequent determination processing (corresponding to step S612). Therefore, similarly to the case of FIG. 17, the relay server 40 can make the registrant with an insufficient balance impassable.

The information processing system 6 according to the present example embodiment is configured to determine whether a person is passable to a restricted area in consideration of not only the collation result of a face feature amount but also the balance information of the candidate, and thus can determine the person who can use a service. Furthermore, since the relay server 40 has the balance information of the candidate before an image is captured by the camera 20 installed in the vicinity of the gate device 50, the relay server 40 can immediately open the gate in the case of determining that the score of collation of the second feature amount of the captured image (second image) captured by the camera 20 with the first feature amount is equal to or larger than the threshold. Moreover, unlike the above-described second example embodiment, the information processing system 6 according to the present example embodiment has a configuration in which the center server 10 includes both the registrant information database 11 and the member information DB 61. Therefore, there is also an advantage that the balance information of the registrant can be acquired without performing authentication processing to an external server.

### Sixth Example Embodiment

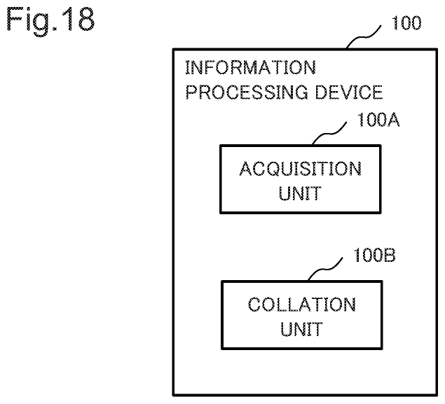

FIG. 18 is a functional block diagram of an information processing device 100 according to a sixth example embodiment. As illustrated in FIG. 18, the information processing device 100 includes an acquisition unit 100A and a collation unit 100B. The acquisition unit 100A acquires a first image obtained by capturing an object at a first distance. Moreover, the acquisition unit 100A acquires a first biological information group including biological information on the first person detected from the first image from a registered biological information group including biological information of a plurality of registrants. The collation unit 100B collates biological information on a second person detected from a second image obtained by capturing the object at a second distance shorter than the distance to the object in the first image with the biological information included in the first biological information group. The information processing device 100 according to the present example embodiment can improve authentication accuracy and authentication speed in face authentication.

### Seventh Example Embodiment

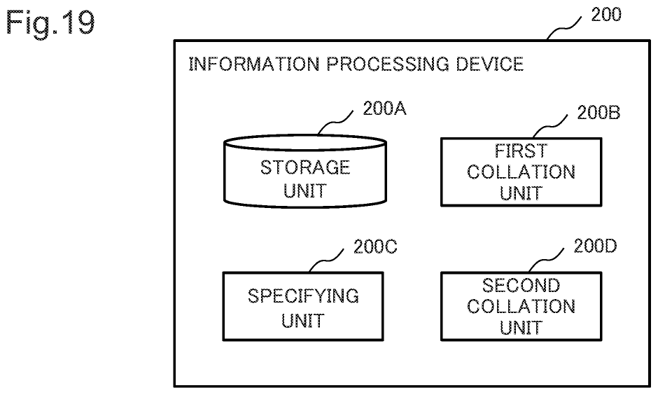

FIG. 19 is a functional block diagram of an information processing device 200 according to a seventh example embodiment. As illustrated in FIG. 19, the information processing device 200 includes a storage unit 200A, a first collation unit 200B, a specifying unit 200C, and a second collation unit 200D. The storage unit 200A stores a registered biological information group including biological information of a plurality of registrants. The first collation unit 200B collates biological information on a first person detected from a first image obtained by capturing an object at a first distance with the biological information included in the registered biological information group. The specifying unit 200C extracts a first biological information group including the biological information on the first person from the registered biological information group on the basis of a collation result in the first collation unit 200B.

The second collation unit 200D collates biological information on a second person detected from a second image obtained by capturing the object at a second distance shorter than the distance to the object in the first image with the biological information included in the first biological information group. The information processing device 200 according to the present example embodiment can improve authentication accuracy and authentication speed in face authentication.

### Eighth Example Embodiment

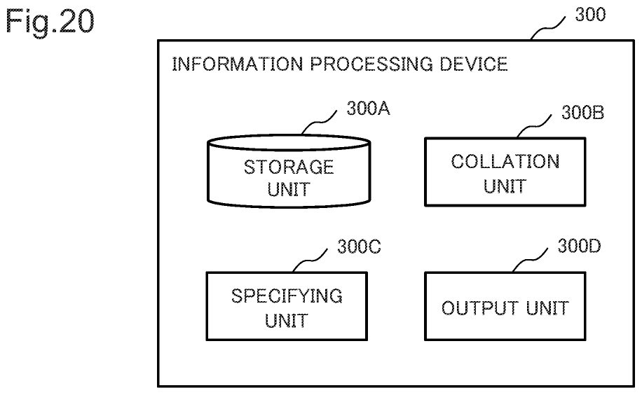

FIG. 20 is a functional block diagram of an information processing device 300 according to an eighth example embodiment. As illustrated in FIG. 20, the information processing device 300 includes a storage unit 300A, a collation unit 300B, a specifying unit 300C, and an output unit 300D. The storage unit 300A stores a registered biological information group including biological information of a plurality of registrants. The collation unit 300B collates biological information on a first person detected from a first image obtained by capturing an object at a first distance with the biological information included in the registered biological information group. The specifying unit 300C extracts a first biological information group including the biological information on the first person from the registered biological information group on the basis of a collation result in the collation unit 300B. The output unit 300D outputs the first biological information group for main authentication using a second image obtained by capturing the object at a second distance shorter than the distance to the object in the first image. The information processing device 300 according to the present example embodiment can improve authentication accuracy and authentication speed in face authentication.

### Ninth Example Embodiment

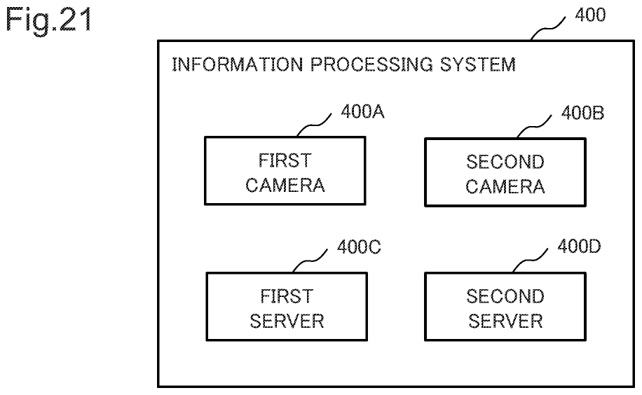

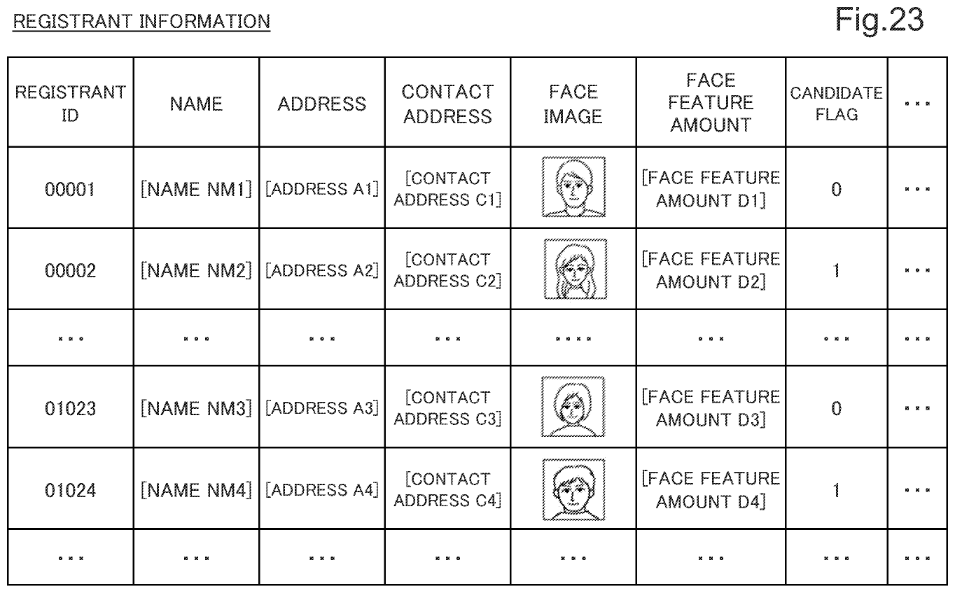

FIG. 21 is a functional block diagram of an information processing system 400 according to a ninth example embodiment. As illustrated in FIG. 23, the information processing system 400 includes a first camera 400A, a second camera 400B, a first server 400C, and a second server 400D. The first camera 400A is installed at a predetermined position, and generates a first image by capturing an object located in a first area (pre-authentication capturing area). The second camera 400B generates a second image by capturing the object located in a second area (main authentication capturing area). The first server 400C collates a registered biological information group including biological information of a plurality of registrants with biological information on a first person detected from the first image, and extracts a first biological information group including the biological information on the first person from the registered biological information group. The second server 400D collates biological information on a second person detected from the second image with the biological information included in the first biological information group. Note that the first camera 400A and the second camera 400B may be the same cameras as described in each of the above example embodiments. In addition, the first camera 400A and the second camera 400B may be two cameras arranged in parallel and provided with lenses having different focal lengths. In this case, the first camera 400A includes a lens suitable for capturing the object located in the first area (pre-authentication capturing area). On the other hand, the second camera 400B includes a lens suitable for capturing the object located in the second area (main authentication capturing area). The information processing system 400 according to the present example embodiment can improve authentication accuracy and authentication speed in face authentication.

### Modified Example Embodiment

The present invention is not limited to the above-described example embodiments, and can be appropriately modified without departing from the gist of the present invention.

In the above-described first example embodiment, the case of determining the presence or absence of the passage authority of the detected person on the basis of the collation result of the feature amount has been described. However, a determination result by a predetermined authentication card (for example, a security card, a transportation IC card, or the like) may be used together with the collation result of the feature amount.

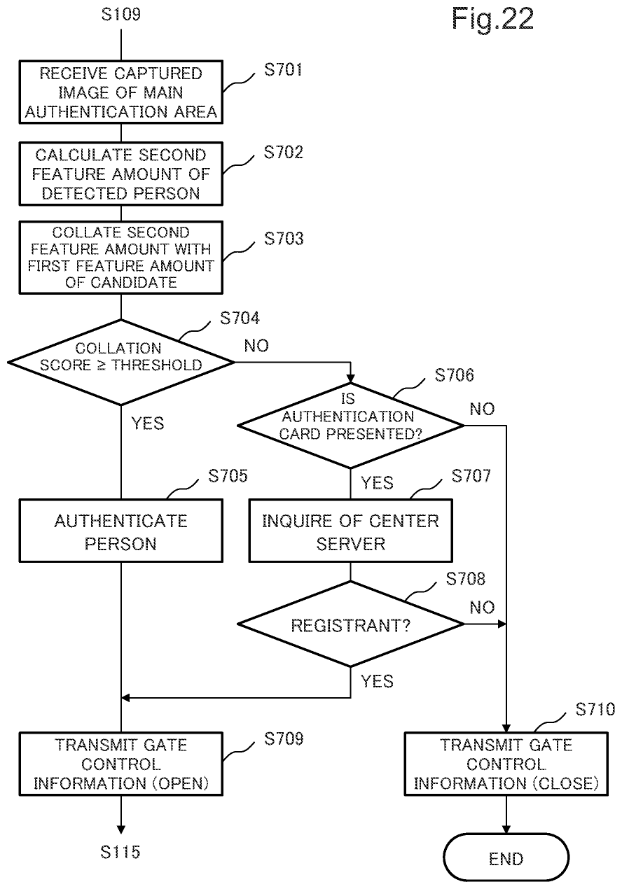

FIG. 22 is a flowchart illustrating an example of processing of the relay server 40 in a modified example embodiment. This processing is performed between step S109 and step S115 in FIG. 7.

First, when receiving the captured image (second image) of the main authentication area (step S701), the relay server 40 calculates the second feature amount of the detected person included in the captured image (second image) (step S702). Next, the relay server 40 collates the calculated second feature amount with the first feature amount of the candidate (step S703).

Next, the relay server 40 determines whether the score of collation of the second feature amount of the detected person with the first feature amount of the candidate is equal to or larger than the predetermined threshold (determination reference value) (step S704). Here, in the case where it is determined that the collation score is equal to or larger than the threshold (step S704: YES), the relay server 40 extracts a person having a high collation score of the feature amount from the corresponding candidates (step S705). Accordingly, the specified candidate (registrant) and the detected person are regarded as the same person. Thereafter, the processing proceeds to step S709. On the other hand, in the case where the relay server 40 determines that the collation score is less than the threshold (step S704: NO), the processing proceeds to step S706.

In step S706, the relay server 40 determines the presence or absence of presentation of the authentication card from the detected person (hereinafter referred to as “person to be authenticated”) in the main authentication area. Here, in a case where the relay server 40 determines the presence of presentation of the authentication card (step S706: YES), the processing proceeds to step S707. On the other hand, in a case where the relay server 40 determines the absence of presentation of the authentication card (step S706: NO), the processing proceeds to step S710.

In step S707, the relay server 40 inquires of the center server 10 whether the person to be authenticated is a registrant on the basis of the authentication information read from the authentication card by a card reader device (not illustrated). Next, the relay server 40 determines whether the person to be authenticated is a registrant on the basis of reply information from the center server 10 (step S708). Here, in a case where the relay server 40 determines that the person to be authenticated is a registrant (step S708: YES), the processing proceeds to step S709. On the other hand, in a case where the relay server 40 determines that the person to be authenticated is not a registrant (step S708: NO), the processing proceeds to step S710.

In step S709, when the relay server 40 transmits the gate control information instructing gate opening to the gate device 50, the processing proceeds to step S115. On the other hand, in step S710, when the relay server 40 transmits the gate control information instructing gate closing to the gate device 50, the processing ends. In this manner, by combining the face authentication and the authentication using the authentication card, the registrant whose face image is not registered can be coped with.

In the above-described fourth example embodiment, the management server 80 includes both the registrant information database 11 (the first storage unit 101) and the candidate information DB 41 (the second storage unit 402), but these databases can be integrated into one database. FIG. 23 is a diagram illustrating an example of the registrant information stored in the management server 80 according to the modified example embodiment. Here, a candidate flag is added to the data item of the registrant information illustrated in FIG. 5. An initial value of the candidate flag is “0”, and in a case where the registrant is specified as the candidate on the basis of the collation result in the pre-authentication capturing area, the value is updated with “1”. Then, when the collation is completed, the collation flag returns to the initial value of “0”. That is, the candidate information is defined in the registrant information. As a result, by collating the feature amount (first feature amount) of the registrant whose candidate flag is “1” with the second feature amount of the detected person included in the captured image of the main authentication area, effects similar to those of the above-described fifth example embodiment can be obtained.

Furthermore, the above-described example embodiments have been described that the candidate information is deleted under three types of deletion conditions: (A) in the case where the person to be authenticated has passed through the gate device 50, (B) in the case where the candidate information regarding the registered feature amount is received again, and (C) in the case where the candidate information on the person included in the captured image of the monitoring area has been registered, but the deletion conditions are not limited thereto. For example, the management server 80 may delete the candidate information on the basis of whether an elapsed time from registration date and time (DB registration time) of the candidate information to the current time has reached a predetermined time. In this case, the candidate information that becomes unnecessary with time can be prevented from remaining in the candidate information DB 41.

Furthermore, in each of the above-described example embodiments, the case in which the camera 20 has only the function to transmit the captured image has been described. However, the camera 20 may further have a function to detect a person from the captured image and calculate and transmit the feature amount. In this case, it is only necessary to transmit the feature amount instead of the captured image to the center server 10 and the relay server 40.

Furthermore, in each of the above-described example embodiments, the case in which the center server 10 transmits only the face feature amount to the relay server 40 has been described. However, a face image of the specified candidate may be transmitted, or the ID of the candidate may be transmitted together with the feature amount and the face image. In the case of transmitting the face image, passage history information including the collated face image of the candidate and the face image of the second person can be generated. Furthermore, in the case of transmitting the ID (registrant ID) of the candidate together and holding the feature amount and the ID in association with each other on the relay server 40 side, not only the collation of the feature amount but also the overlapping candidate information can be extracted and deleted on the basis of the collation result of the ID.

Furthermore, in the above-described first to fourth example embodiments, the case in which one relay server 40 is installed in one base has been described, but a plurality of relay servers may be installed in one base. For example, in a facility having an extremely large number of users, there is an advantage that the collation processing can be performed in a distributed manner by installing a plurality of the relay servers 40. In this case, it is favorable to control data registration so as not to hold overlapping candidate information among the plurality of relay servers 40.

Furthermore, in each of the above-described example embodiments, the case in which the threshold at the time of collation using the pre-authentication image and the threshold at the time of collation using the main authentication image are the same value has been described, but the threshold may be different between the pre-authentication area and the main authentication area. For example, the threshold at the time of collation in the pre-authentication area may be set to be lower than the threshold at the time of collation in the main authentication area. This has an advantage that omission of extraction of candidates in the pre-authentication area can be prevented. On the contrary, the threshold at the time of collation in the pre-authentication area may be set to be higher than the threshold at the time of collation in the main authentication area. Accordingly, the pre-authentication can be executed under a strict condition. In addition, in the case where a plurality of pre-authentication areas is set, the threshold at the time of collation in each pre-authentication area may be set so as to gradually increase as approaching the restricted area. As a result, the person to be authenticated (candidate) in the authentication using the main authentication image can be gradually narrowed down according to the distance from each pre-authentication area to the restricted area.

Furthermore, in each of the above-described example embodiments, the case in which the candidate information (first feature amount) on the same person is not redundantly registered even in the case where the same person is detected a plurality of times in the pre-authentication image, and the number of times of detection is not considered has been described. However, in a case where the camera 20 transmits a plurality of pre-authentication images, the same person may be captured a plurality of times. Therefore, in the case where the same person is detected a plurality of times in the plurality of pre-authentication images, the threshold at the time of collation using the main authentication image may be changed (to be high or low) according to the number of times of detection. As a result, for example, a person detected a predetermined number of times or more in the pre-authentication image scan be strictly authenticated as a person to watch out by making the threshold in the main authentication images higher than usual. Conversely, the authentication can be performed by setting the threshold in the authentication area to be lower than usual.

A processing method of recording a program for operating the configurations of the above-described example embodiments to implement the functions of the example embodiments, reading the program recorded on the storage medium as a code, and executing the program in a computer is also included in the scope of each of the example embodiments. That is, a computer-readable storage medium is also included in the scope of each of the example embodiments. In addition, not only the storage medium in which the above-described program is recorded but also the program itself is included in each of the example embodiments. In addition, one or more configuration elements included in the above-described example embodiments may be a circuit such as an application specific integrated circuit (ASIC) or a field programmable gate array (FPGA) configured to implement the functions of the configuration elements.

Examples of the storage medium include a floppy (registered trademark) disk, a hard disk, an optical disk, a magneto-optical disk, a compact disk (CD)-ROM, a magnetic tape, a non-volatile memory card, and a ROM. In addition, not only a configuration in which the processing is executed by the program recorded on the recording medium alone but also a configuration in which the processing is executed on an operating system (OS) in cooperation with another software or functions of an extension board is also included in the scope of each of the example embodiments.

The service implemented by the functions of each of the above-described example embodiments can also be provided to the user in the form of software as a service (SaaS).

Note that the above-described example embodiments are merely examples of embodiment in implementing the present invention, and the technical scope of the present invention should not be interpreted in a limited manner by these example embodiments. That is, the present invention can be implemented in various forms without departing from the technical idea or the main features thereof. For example, the relay server 40 described in each of the above-described example embodiments can be configured by an information processing device built in the gate device 50. Moreover, in a case where there is a plurality of gate devices 50, it is also possible to adopt a configuration in which information processing devices functioning as the relay server 40 share information with each other.

Some or all of the above-described example embodiments can be described as but are not limited to the following supplementary notes.
(Supplementary Note 1)

An information processing device including:

an acquisition unit configured to acquire a first image obtained by capturing an object at a first distance, and extract, from a registered biological information group including biological information of a plurality of registrants, a first biological information group including biological information on a first person detected from the first image obtained by capturing the object at the first distance; and

a collation unit configured to collate biological information on a second person detected from a second image obtained by capturing the object at a second distance shorter than the distance to the object in the first image with the biological information included in the first biological information group.
(Supplementary Note 2)

The information processing device according to supplementary note 1, further including:

a detection unit configured to detect the biological information on the second person from the second image.
(Supplementary Note 3)

The information processing device according to supplementary note 1 or 2, further including:

a determination unit configured to determine presence or absence of passage authority of the second person to a predetermined restricted area based on a collation result of the collation unit.
(Supplementary Note 4)

The information processing device according to supplementary note 3, further including:

a control unit configured to control opening and closing of a door of a passage restriction device that restricts entry and exit to and from the restricted area based on the presence or absence of the passage authority.
(Supplementary Note 5)

The information processing device according to supplementary note 3 or 4, further including:

a balance information acquisition unit configured to acquire balance information of the first person, in which

the determination unit determines the presence or absence of the passage authority of the second person to the restricted area based on the collation result and the balance information.
(Supplementary Note 6)

The information processing device according to any one of supplementary notes 1 to 5, further including:

a storage unit configured to store the acquired first biological information group; and

a deletion unit configured to delete the biological information on the first person, the biological information meeting a predetermined condition, from the first biological information group.
(Supplementary Note 7)

The information processing device according to supplementary note 6, in which

the deletion unit deletes the biological information on the first person of which an elapsed time from registration time to the storage unit has reached a predetermined time.
(Supplementary Note 8)

The information processing device according to supplementary note 6 or 7, in which,

in a case where a plurality of pieces of the biological information for the first person is present in the storage unit, the deletion unit deletes the biological information having earlier registration time to the storage unit.
(Supplementary Note 9)

An information processing device including:

a storage unit configured to store a registered biological information group including biological information of a plurality of registrants;

a first collation unit configured to acquire a first image obtained by capturing an object at a first distance and collate biological information on the first person detected from the first image with biological information included in the registered biological information group;

a specifying unit configured to extract a first biological information group including the biological information on the first person from the registered biological information group based on a collation result in the first collation unit; and

a second collation unit configured to collate biological information on a second person detected from a second image obtained by capturing the object at a second distance shorter than the distance to the object in the first image with biological information included in the first biological information group.
(Supplementary Note 10)

An information processing system including:

a first server configured to acquire a first image obtained by capturing an object at a first distance, collate a registered biological information group including biological information of a plurality of registrants with biological information on a first person detected from the first image, and extract a first biological information group including the biological information on the first person from the registered biological information group; and

a second server configured to collate biological information on a second person detected from a second image obtained by capturing the object at a second distance shorter than the distance to the object in the first image with biological information included in the first biological information group.
(Supplementary Note 11)

The information processing system according to supplementary note 10, in which

the second server

determines presence or absence of passage authority of the second person to a predetermined restricted area, and

controls opening and closing of a door of a passage restriction device that restricts entry and exit to and from the predetermined restricted area based on the presence or absence of the passage authority.
(Supplementary Note 12)

The information processing system according to supplementary note 10 or 11, in which

a reference value for determining matching in the collation of the biological information on the registrant with the biological information on the first person in the first server is set to be lower than a reference value for determining matching in the collation of the biological information on the first person with the biological information on the second person in the second server.
(Supplementary Note 13)

The information processing system according to supplementary note 10 or 11, in which

a reference value for determining matching in the collation of the biological information on the registrant with the biological information on the first person in the first server is set to be higher than a reference value for determining matching in the collation of the biological information on the first person with the biological information on the second person in the second server.
(Supplementary Note 14)

The information processing system according to any one of supplementary notes 10 to 13, in which

a reference value at the time of collation of the biological information on the first person with the biological information on the second person is determined according to the number of times of detecting a same person by the collation of the registered biological information group with the biological information on the first person.
(Supplementary Note 15)

An information processing method including:

acquiring a first image obtained by capturing an object at a first distance;

extracting, from a registered biological information group including biological information of a plurality of registrants, a first biological information group including biological information on a first person detected from the first image;

acquiring a second image obtained by capturing the object at a second distance shorter than the distance to the object in the first image; and

collating biological information on a second person detected from the second image with the biological information included in the first biological information group.
(Supplementary Note 16)

A program recording medium recording a program for causing a computer to execute:

processing of acquiring a first image obtained by capturing an object at a first distance;

processing of extracting, from a registered biological information group including biological information of a plurality of registrants, a first biological information group including biological information on a first person detected from the first image;

processing of acquiring a second image obtained by capturing the object at a second distance shorter than the distance to the object in the first image; and

processing of collating biological information on a second person detected from the second image with the biological information included in the first biological information group.

### REFERENCE SIGNS LIST

1, 2, 3, 4, 5, 6 information processing system
10 center server
11 registrant information database
20 camera
40 relay server
41 candidate information database
50 gate device
51 sensor
60 external server
80 management server
101 first storage unit
102 first collation unit
103 candidate information output unit
401 candidate information acquisition unit
402 second storage unit
403 image acquisition unit
404 feature amount calculation unit
405 second collation unit
406 determination unit
407 gate control unit
408 candidate information deletion unit
151 and 451 CPU
152 and 452 RAM
153 and 453 ROM
154 and 454 HDD
155 and 455 communication I/F
156 and 456 display device
157 and 457 input device
158 and 458 bus

What is claimed is:

1. An information processing device comprising:
one or more memories storing instructions; and
one or more processors configured to execute the instructions to:
acquire a first image obtained by capturing an object at a first distance, and extract, from a registered biological information group including biological information of a plurality of registrants, a first biological information group including biological information on a first person detected from the first image; and
collate biological information on a second person detected from a second image obtained by capturing the object at a second distance shorter than the distance to the object in the first image with the biological information included in the first biological information group.

2. The information processing device according to claim 1,
wherein the one or more processors are configured to execute the instructions to detect the biological information on the second person from the second image.

3. The information processing device according to claim 1,
wherein the one or more processors are configured to execute the instructions to determine presence or absence of passage authority of the second person to a predetermined restricted area based on a collation result.

4. The information processing device according to claim 3,
wherein the one or more processors are configured to execute the instructions to control opening and closing of a door of a passage restriction device that restricts entry and exit to and from the restricted area based on the presence or absence of the passage authority.

5. The information processing device according to claim 3,
wherein the one or more processors are configured to execute the instructions to:
acquire balance information of the first person; and
determine the presence or absence of the passage authority of the second person to the restricted area based on the collation result and the balance information.

6. The information processing device according to any one of claim 1,
wherein the one or more processors are configured to execute the instructions to:
store the acquired first biological information group; and
delete the biological information on the first person, the biological information meeting a predetermined condition, from the first biological information group.

7. The information processing device according to claim 6,
wherein the one or more processors are configured to execute the instructions to delete the biological information on the first person of which an elapsed time from registration time has reached a predetermined time.

8. The information processing device according to claim 6,
wherein the one or more processors are configured to execute the instructions to, in a case where a plurality of pieces of the biological information for the first person is present, delete the biological information having earlier registration time.

9. (canceled)

15. An information processing method comprising:
acquiring a first image obtained by capturing an object at a first distance;
extracting, from a registered biological information group including biological information of a plurality of registrants, a first biological information group including biological information on a first person detected from the first image;
acquiring a second image obtained by capturing the object at a second distance shorter than the distance to the object in the first image; and
collating biological information on a second person detected from the second image with the biological information included in the first biological information group.

16. A non-transitory program recording medium recorded with a program for causing a computer to execute:
processing of acquiring a first image obtained by capturing an object at a first distance;
processing of extracting, from a registered biological information group including biological information of a plurality of registrants, a first biological information group including biological information on a first person detected from the first image;
processing of acquiring a second image obtained by capturing the object at a second distance shorter than the distance to the object in the first image; and
processing of collating biological information on a second person detected from the second image with the biological information included in the first biological information group.
